(19) United States
(12) Patent Application Publication
(10) Pub. No.: US 2025/0269995 A1
(43) Pub. Date: Aug. 28, 2025

(54) MACHINE FOR TAPING A SEMI-FINISHED PRODUCT AND RELATED SEMI-FINISHED PRODUCT FOR MAKING A MATTRESS

(71) Applicant: Roberto TROVI, Quarrata (Pistoia) (IT)

(72) Inventor: Roberto TROVI, Quarrata (Pistoia) (IT)

(21) Appl. No.: 19/061,253

(22) Filed: Feb. 24, 2025

(30) Foreign Application Priority Data
Feb. 26, 2024 (IT) 102024000003964

(51) Int. Cl. B65B 51/06; B68G 7/12

(52) U.S. Cl. CPC B65B 51/06; B68G 7/12

(57) ABSTRACT

A machine for taping a semi-finished product, including a supporting surface for the semi-finished product; and a taping device movable on a surface parallel to the supporting surface and configured to apply at least one containment web on the semi-finished product.

This application claims priority to Italian Patent Application 102024000003964filed Feb. 26, 2024, the entirety of which is incorporated by reference herein.

The present invention relates to a machine for taping a semi-finished product.

In particular, the present invention relates to a machine for taping a semi-finished product in which such semi-finished product is defined by a single block sheet comprising a pack of springs and a frame of longitudinal members.

Even more specifically, the present invention relates to a machine for taping a semi-finished product for the subsequent production of a mattress starting from the semi-finished product itself.

The present invention also has as its object a related semi-finished product for making a mattress.

To date, semi-finished products for making mattresses are known, in which such semi-finished products are composed of a single sheet presenting a pack of springs and four longitudinal members fixed laterally on it.

The structure of such semi-finished products allows such maneuverability as to simplify the production of the mattress during the production phase.

In fact, the possibility of maneuvering the semi-finished product as a real sheet defined by a single block makes it possible to simplify the application of an upper layer and a lower layer to the semi-finished product, applying for such a semi-finished product, the same production process that is applied, for example, to the manufacture of mattresses from sheets of foam material.

While these features make it possible to simplify the production processes of mattresses from semi-finished products, it is also true that the machines for making semi-finished products and their known semi-finished products show some important drawbacks.

A first drawback of the machines and known semi-finished products is given by the fact that generally, they do not allow for the provision of a semi-finished product with optimized and stable dimensions.

In particular, the spring pack of the semi-finished product does not ensure the maintenance of its own parallelepiped shape, basically tending to expand at certain points.

This implies that the shape of the semi-finished product, during the production phase of the mattress, tends to deform in such a way that it is no longer suitable for the gluing of an upper layer and a lower layer for making the mattress itself. Another drawback of the machines and known semi-finished products is given by the fact that they are not always able to ensure an optimal qualitative outcome of the final product.

It is therefore an object of the present invention to provide a machine for taping a semi-finished product and a related semi-finished product for making a mattress that is capable of solving the drawbacks of the state of the art.

Another object of the present invention is to provide a taping machine for a semi-finished product and related semi-finished product for making a mattress capable of optimizing production quality.

Another object of the present invention is to provide a taping machine for a semi-finished product and related semi-finished product for making a mattress that are simple to implement and cost-effective.

Another object of the present invention is to provide a taping machine for a semi-finished product and related semi-finished product for making a mattress that are designed to provide a product (semi-finished product) capable of maintaining its shape throughout the production phase of a mattress.

According to the invention, these objects and others are achieved by a taping machine for a semi-finished product and related semi-finished product for making a mattress presenting the technical characteristics described in the attached claims.

The technical characteristics of the invention, according to the objects set out above, are clearly described in the attached claims and its advantages are evident from the detailed description that follows, with reference to the attached drawings which illustrate purely exemplary and non-limiting embodiments thereof, wherein:

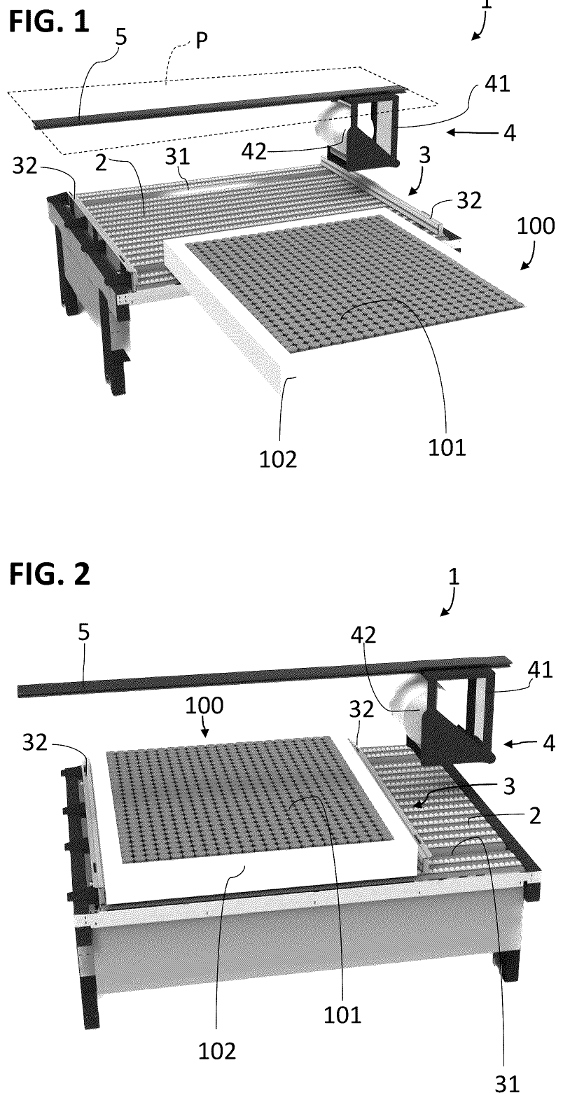

FIG. 1 illustrates a schematic lateral view in perspective from above of a taping machine for a semi-finished product and the related semi-finished product, according to a first configuration of use;

FIG. 2 illustrates a schematic lateral view in perspective from above of the machine and the semi-finished product referred to in FIG. 1, according to a further configuration of use;

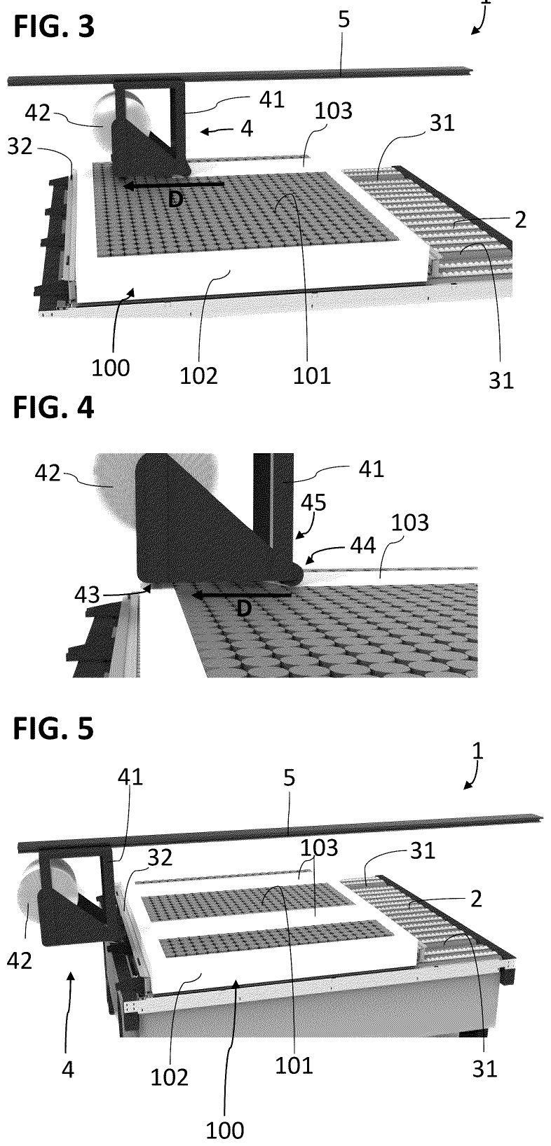

FIG. 3 illustrates a schematic lateral view in perspective from above of the machine and the semi-finished product referred to in FIG. 1, according to a third configuration of use;

FIG. 4 illustrates a schematic lateral view of a detail of the machine and the semi-finished product in FIG. 1, and

FIG. 5 illustrates a schematic lateral view in perspective from above of the machine and the semi-finished product in FIG. 1, according to a fourth configuration of use.

With reference to the attached figures, the reference number 1 indicates a taping machine for a semi-finished product 100, hereinafter also referred to simply as machine 1.

In detail, the semi-finished product 100 is defined by a single-block sheet comprising a spring pack 101 and a plurality of lateral longitudinal members 102.

In particular, semi-finished product 100 means a single-block sheet on which, in a subsequent production phase, an upper layer and a lower layer are applied by gluing so as to make a mattress.

The machine 1 object of the present invention comprises a supporting surface 2 for the semi-finished product 100.

The machine 1 comprises lateral containment means 3 of the semi-finished product 100.

Such containment means 3 are adjustable on the supporting surface 2 so as to adapt to the dimensions of the semi-finished product 100.

Advantageously, the lateral containment means 3 comprise at least one sliding track 31 obtained on the supporting surface 2.

According to the embodiment visible in the attached figures, the lateral containment means 3 comprise two sliding tracks 31.

Furthermore, advantageously, the containment means 3 comprise a pair of containment barriers 32 suitable for sliding and fixing on the sliding tracks 31 so as to contain the semi-finished product 100 on at least two sides.

Substantially, the barrier pair 32 is adjustable in length and can be fixed on the tracks 31 so as to obtain a distance between the two barriers of the pair 32 being suitable for the size of the semi-finished product 100.

The machine 1 object of the present invention comprises a taping device 4 movable on a plane P parallel to the supporting surface 2.

The taping device 4 is configured to apply a containment web 103 on at least one stretch of the semi-finished product 100.

According to the embodiment illustrated in FIG. 5, the web 103 is applied on at least two stretches of the semi-finished product 100.

The term stretch means any one of a portion: of the upper surface, of the lower surface, of any lateral surface of the semi-finished product 100.

The application of the web 100 on at least two stretches of the semi-finished product therefore means that such web 100 is applied for example on at least: a portion of the upper surface and a portion of one of the lateral surfaces, or, on a portion of the lower surface and a portion of any of the lateral surfaces. This does not mean that the web 103 cannot be applied on three or more stretches of the semi-finished product 100, or on the entire upper surface (or lower surface or both) of the semi-finished product 100.

Advantageously, the web 103 is a TNT web, i.e. non-woven fabric.

Advantageously, the web 103 is made of a material that allows the containment of the spring pack so as to avoid its expansion during the production process of the mattress.

Maintaining the semi-finished product at an optimal dimension allows excellent quality results to be obtained in the subsequent production of the mattress, in addition to the fact that it simplifies and speeds up the operations for its production.

According to a first embodiment not illustrated, the machine 1 object of the present invention comprises means (not illustrated) for overturning the semi-finished product 100, so that the taping device 4 can apply the web 103 on both the upper and lower face of the semi-finished product 100 itself, thereby giving shape to a closed loop taping.

According to a further embodiment not illustrated, the machine 1 object of the present invention comprises a second taping device suitable for applying a web 103 on at least a stretch of a lower surface of the semi-finished product 100.

This second taping device is movable on a plane parallel to the plane P and to the supporting surface 2.

According to this embodiment, the supporting surface 2 has at least one opening to allow the application of the web 103 on the lower surface of the semi-finished product 100.

Advantageously, the web 103 is applied to a length of the semi-finished product 100.

In addition or alternatively, the web 103 is applied to a width of the semi-finished product 100. Advantageously, the web 103 is applied to the spring pack 101.

Advantageously, the web 103 is applied to the entire length (or width) of the semi-finished product 100 defined by the spring pack 101 and the longitudinal members 102.

The web 103 is applied by gluing using a quick-setting hot melt glue.

Advantageously, this glue is water-based.

The machine 1 object of the present invention advantageously comprises guiding means 5 of the device 4.

Advantageously, the taping device 4 comprises a containment and movement carriage 41.

The containment and movement carriage 41 is designed to slide on the guide means 5.

In particular, such guide means 5 allow movement of such carriage 41 on the plane P parallel to the supporting surface 2, so as to allow mobility on at least two Cartesian axes.

Advantageously, the taping device 4 comprises a reel 42 of containment web 103.

Such reel 42 is arranged on the carriage 41.

With reference to the attached FIG. 4, the device 4 comprises gluing means 43 configured to apply glue to the semi-finished product 100 at a gluing area of the web 103.

The device 4 advantageously also comprises a pressure roller 44 suitable for pressing the web 103 onto the semi-finished product 100 at the gluing zone. Advantageously, the device 4 also comprises cutting means 45 suitable for cutting the web 103 from the reel 42.

Basically, the gluing means are placed on a front portion of the carriage 41 along a feed direction D of the carriage 41 itself, while the pressure roller 44 is arranged on a rear portion of the carriage 41.

In other words, when carriage 41 slides along the feed direction D, first the gluing means 43 and then the pressure roller 44 act on the semi-finished product 100, so that the web 103 is applied with enough pressure to glue it on the gluing zone where the gluing means 43 have previously acted.

Another object of the present invention is a semi-finished product 100 for making a mattress.

The semi-finished product 100 comprises a spring pack 101.

The semi-finished product 100 also comprises a plurality of longitudinal members 102 stably fixed to the spring pack 101.

Advantageously, these longitudinal members 102 are fixed to the spring pack 101 by gluing and define with it a single block that is easily manipulated.

The optimal maneuverability of the single block allows for optimizing the production quality of the mattress, thus facilitating assembly thereof.

The semi-finished product 100 also comprises a containment web 103 glued to at least one stretch of the semi-finished product 100.

This stretch extends over at least one stretch of the spring pack 101.

Advantageously, this stretch extends both on the spring pack 101 and on the plurality of longitudinal members 102.

Advantageously, therefore, the web is shaped like a band, that is, having a dimension (length) much greater than the other dimension (width), considering the minimum thickness, as illustrated in FIG. 5. According to the embodiment illustrated in FIG. 5, the semi-finished product 100 comprises a pair of webs 103 extending along an upper surface of the spring pack 101.

Advantageously, the semi-finished product 100 comprises a second pair of webs 103 extending along a lower surface of the spring pack 101.

The web 103 advantageously comprises TNT, that is, non-woven fabric.

Advantageously, this web 103 is fixed on the spring pack 101 and on the longitudinal members 102 by means of a quick-setting hot melt adhesive.

The web 103 allows to maintain the semi-finished product 100 at a predefined size for the entire production range of the mattress, avoiding unwanted expansions of the spring pack 101, for example. Maintaining the semi-finished product 100 at a predefined dimension allows to optimize the quality of the mattress, as it ensures a perfect coupling between the semi-finished product 100 and the upper and lower layers that are subsequently applied thereto, thus obtaining the finished product (mattress).

Advantageously, the web 103 has a thickness that ensures the holding of the semi-finished product 100 during the production process, but that can also break during the use of the finished product (mattress) by a user.

Advantageously, the web 103 is applied both on a upper surface of the semi-finished product 100 and on a lower surface of the same.

The taping machine of a semi-finished product and the related semi-finished product for making a mattress object of the present invention allow to solve the drawbacks of the state of the art and achieve important advantages.

A first advantage of the machine and the semi-finished product according to the present invention is to provide a product (semi-finished product) able to stably maintain its dimension until the production process for making a mattress is finished, basically ensuring the containment of possible expansions or distortions of the volume identified by the semi-finished product itself.

Another advantage of the machine and the semi-finished product according to the present invention is to ensure optimal production efficiency, which helps to contain costs and optimize quality in production.

1. A machine for taping a semi-finished product, wherein said semi-finished product is defined by a single-block sheet comprising a pack of springs and a plurality of lateral longitudinal members, said machine comprising:
a supporting surface for said semi-finished product;
means for lateral containment of said semi-finished product, said containment means being adjustable on said supporting surface in such a way as to adapt to the dimensions of said semi-finished product;
a taping device movable on a plane parallel to said supporting surface and configured for applying a containment web on at least one stretch of said semi-finished product.

2. The machine according to claim 1, wherein said machine comprises means for guiding said device, said machine being characterised in that said taping device comprises a containment and movement carriage, said carriage being designed to engage in a sliding fashion on said guide means.

3. The machine according to claim 2, wherein said taping device comprises:
a reel of containment web, said reel being positioned on said carriage,
gluing means configured for applying an adhesive on said semi-finished product at a zone for gluing said web,
a pressure roller designed to press said web on said semi-finished product at said gluing zone;
cutting means designed to cut said web from said reel.

4. The machine according to claim 1, wherein said lateral containment means comprise at least one sliding track formed on said supporting surface, and a pair of containment barriers designed to slide and be fixed on said at least one sliding track for containing said semi-finished product at least on two sides.

5. The machine according to claim 1, wherein it comprises means for overturning said semi-finished product, in such a way that said taping device can apply said containment web both on an upper face and on a lower face of said semi-finished product.

6. The machine according to claim 1, wherein it comprises a second taping device designed to apply said web on at least one stretch of a lower surface of said semi-finished product, when said taping device is designed to apply said web on at least one stretch of an upper surface of said semi-finished product.

7. The machine according to claim 1, wherein said web is applied on a stretch of length of said semi-finished product.

8. The machine according to claim 1, wherein said web is applied on said pack of springs.

9. The machine according to claim 1, wherein said web is applied on said pack of springs and on said longitudinal members.

10. A semi-finished product for making a mattress, said semi-finished product comprising a pack of springs, a plurality of longitudinal members and at least one containment web glued on said semi-finished product at least along a stretch of extension of said pack of springs, and a stretch of at least one longitudinal member of said plurality of longitudinal members.

11. The semi-finished product for making a mattress according to claim 10 wherein said containment web is glued to at least one upper surface of said pack of springs and to a lateral surface of at least one longitudinal member of said plurality).

12. The semi-finished product for making a mattress according to claim 10 wherein said web has an area smaller than the area of the upper surface of said pack of springs.

13. The semi-finished product for making a mattress according to claim 10 comprising two containment webs.
